(19) United States
(12) Patent Application Publication
(10) Pub. No.: US 2023/0213683 A1
(43) Pub. Date: Jul. 6, 2023

(54) Real-Time Correction of Calibration Constants of a Bore-Hole Logging Tool Using a Reference Detector

(71) Applicant: Visuray intech Ltd (BVI), Road Town (VG)

(72) Inventors: Philip Teague, Houston, TX (US); Robert Sloan, Park City, UT (US)

(73) Assignee: Visuray Intech Ltd (BVI), Road Town (VG)

(21) Appl. No.: 18/120,451

(22) Filed: Mar. 13, 2023

Related U.S. Application Data
(63) Continuation of application No. 17/679,721, filed on Feb. 24, 2022, now abandoned.
Application No. 17/679,721 is a continuation of application No. 17/140,869, filed on Jan. 4, 2021, now abandoned.
Application No. 17/140,869 is a continuation of application No. 15/902,031, filed on Feb. 22, 2018, now Pat. No. 10,490,290.
(60) Provisional application No. 62/463,048, filed on Feb. 24, 2017.

(51) Int. Cl. G01V 5/12; G01V 13/00; E21B 49/00

(52) U.S. Cl. CPC G01V 5/12; G01V 13/00; E21B 49/00

(57) ABSTRACT

An x-ray based litho-density tool for measurement of formation surrounding a borehole is provided, the tool including at least an internal length comprising a sonde section, wherein said sonde section further comprises an x-ray source; at least one radiation measuring detector; at least one source monitoring detector; a plurality of sonde-dependent electronics; and a reference detector, wherein the reference detector is used to monitor the output of the x-ray source such that the reference detector's output effects corrections to the outputs of the detectors used to measure the density of the materials surrounding the borehole in order to correct for variations in the x-ray source output. Tool logic electronics, PSUs, and one or more detectors used to measure borehole standoff such that other detector responses maybe compensated for tool standoff are also provided. Shielding, through-wiring; wear-pads that improve the efficacy and tool functionality are also described and claimed.

### CROSS-REFERENCES TO RELATED APPLICATIONS

This patent application claims benefit of U.S. patent application Ser. No. 17/679,721, filed Feb. 24, 2022, which claims benefit of U.S. patent application Ser. No. 17/140.869, filed Jan. 4, 2021, which claims benefit of U.S. patent application Ser. No. 15/902.031, filed Feb. 22, 2018, which claims the benefit of U.S. Provisional Patent Application No. 62/463,048, filed Feb. 24, 2017, the contents of which are hereby incorporated by reference in their entirety.

### FIELD OF THE INVENTION

The present invention relates generally to methods and means for real-time correction of calibration constants of a bore-hole logging tool, and in a particular though non-limiting embodiment to methods and means of real-time correction of calibration constants of a logging tool using a reference detector.

### BACKGROUND

In borehole formation density logging, it is important to ensure the highest accuracy of data, whereby any variation in that data is a result of the change in scattering and attenuation properties of the formation itself (formation density) or controllable borehole effects. When using electronic radiation emitting source tubes as a replacement for radio-active isotope-based radiation sources, an inherent variability is introduced into the measurement due to the unstable nature of the output of the source tube and its power supply—an issue which is not encountered during the use of highly stable long half-life radio isotopes. As a result, the variations in the measured data which would normally be attributable to formation density alone can contain a variable component of the instability of the source tube itself.

With market available borehole logging tools, the formation-facing detectors are calibrated through the use of small radioisotopes which are located within the detector assembly. Radioisotopes such as ¹³⁷Cs are employed due to the dominant and narrow energy peaks which do not contribute greatly to the output count rate of the detector but can be actively used as an energy marker by the detector electronics to modify the gain control voltage of the photomultiplier tube such that the output is stabilized against temperature variations and other environmental factors. However, market available borehole logging tools employ radioisotopes as their primary radiation source to illuminate the formation surrounding the borehole. Due to the relatively long half-life of the radioactive isotopes employed as primary radiation sources, their output is highly stable and predictable over the period of a borehole logging operation, and the exact output of the isotope can be measured at the surface prior to the operation to use as a reference point. Because of the highly stable output of the primary radiation source, and the gain stabilization control isotope method employed within the detector systems, the only two major variants in the statistical output of the formation-facing detectors are the change in scattering and attenuation properties of the formation itself; and the offset of the detectors from the borehole wall, which can introduce direct radiation from the primary source being counted by the detectors as a result of borehole propagation of the primary radiation through the borehole fluid between the primary source and the detector. The former being the desired measurement and the latter being compensated for by the use of more than one detector, each linearly offset along the longitudinal direction of the borehole from the primary source.

If x-ray source tubes are used as a replacement for the radio-active isotope, instabilities can be introduced into the output of the source. Typically, the output of an x-ray source can be controlled by means of an electrical feedback loop consisting of a sensing circuit connected to the highest voltage stage of the high voltage power supply, which is then used to regulate the input voltage of high voltage power supply with the aim of stabilizing the supply voltage of an x-ray tube. However, small changes in the geometry of the source tube itself, e.g., due to thermal expansion or contraction, parasitic electronic charges causing electron beam movement, beam-spot focusing variations or target anode to collimation geometry variations, can lead to minor variations in the geometry and spectrum of the output beam of the source, directly affecting the accuracy of the formation count-rate measurement detrimentally.

Various means have been published which attempt to mitigate this issue by additional control of the source tube itself or through adaptive calibration of the formation-facing detectors.

For example, U.S. Pat. No. 7,564,948 B2 to Wraight et al. discloses a reference detector placed at the opposite end of a through-shielding channel (thereby collimating the primary x-ray signal) and additionally filtered via various materials to produce a bi-peak spectrum. The energy and intensity of the two peaks is then analyzed and used as a direct feedback to control either the input voltage or current, or both, of the x-ray tube in an attempt to stabilize the x-ray output.

U.S. Pat. No. 7,960,687 to Simon et al. discloses a reference detector placed at the opposite end of an elbowed through-shielding channel (thereby collimating the primary x-ray signal) and additionally filtered via various materials to produce a multi or bi-peak spectrum. The elbow-shaped geometry is employed to help the reference detector's tendency to saturate due to the intensity of a direct primary radiation beam. The energy and intensity of the peaks is then analyzed and used as a direct feedback to control or actively modify the control voltage for the stabilization gain of the formation facing detectors' photo multiplier tubes, in an attempt to actively compensate for the instabilities in the output of the x-ray source. In short, the reference proposes to replace the inherent gain stability of an embedded micro-isotope-based approach with an unstable x-ray source instability-based feedback gain stabilization method. The logged data would therefore be permanently modified at the detector and all record of the actual statistical output, compared to a micro-isotope gain stabilized detector, would be lost. Consequently, any control algorithm errors could not later be corrected for at the surface.

U.S. Pat. No. 7,564,948 and U.S. Pat. No. 7,960,687 disclose systems that directly control either the source tube based on the reference detector output or the formation-facing detectors' stabilization gain based on the reference detector output (spectral reference feedback loop). The references teach that the detected output of the x-ray tube to determine the correct calibration constant corrections to be substituted during the computation of detector count-rate output prior to or during the density computation itself.

### SUMMARY

An x-ray based litho-density tool for measurement of formation surrounding a borehole is provided, the tool including at least an internal length comprising a sonde section, wherein said sonde section further comprises an x-ray source; at least one radiation measuring detector; at least one source monitoring detector; a plurality of sonde-dependent electronics; and a reference detector, wherein the reference detector is used to monitor the output of the x-ray source such that the reference detector's output effects corrections to the outputs of the detectors used to measure the density of the materials surrounding the borehole in order to correct for variations in the x-ray source output. Tool logic electronics, PSUs, and one or more detectors used to measure borehole standoff such that other detector responses maybe compensated for tool standoff are also provided. Shielding, through-wiring, wear-pads and the like that improve the efficacy and functionality of the tool are also provided.

### BRIEF DESCRIPTION OF THE DRAWINGS

FIG. 1 illustrates an x-ray based litho-density formation evaluation tool deployed by wireline conveyance into a borehole, wherein the formation density is measured by the tool.

FIG. 2 is a layout view of a practical means of exercising the method within the confines of a borehole tool configured to measure formation density and borehole corrections using an x-ray tube as a radiation source.

FIG. 3 illustrates a typical reference detector spectrum for a Compton range source, showing Intensity in the y-axis versus photon energy in the x-axis, the windowed region of interest (the region between two specified energies) remains unchanged as the spectrum peak intensity moves.

### BRIEF DESCRIPTION OF SEVERAL EXAMPLE EMBODIMENTS

The invention described herein consists of methods and apparatus to use the detected output of a non-isotope-based radiation source tube within a borehole logging tool to determine the correct calibration constant corrections to be substituted during the computation of detector count-rate output prior to, or during, the computation of formation density itself In borehole formation density logging, it is important to ensure the highest accuracy of data, whereby any variation in that data is a result of the change in scattering and attenuation properties of the formation itself (formation density) or controllable borehole effects. When using electronic radiation emitting source tubes as a replacement for radio-active isotope-based radiation sources, an inherent variability is introduced into the measurement due to the unstable nature of the output of the source tube and its power supply—an issue which is not encountered during the use of highly stable long half-life radio isotopes. Consequently, the variations in the measured data that would normally be attributable to formation density alone can contain a variable component of the instability of the source tube itself This invention teaches of a method and a means to measure the output radiation of a source tube and to use this data as an input to a calibration correction algorithm prior to or during density computation.

An example method of practicing the invention comprises a combination of known and new technologies embodied in a new application with respect to radiation physics and formation evaluation measurements for use within the oil and gas industry. The method is further embodied by a means, which may be used to practice the method for use in a water, oil or gas well,

The typical regulatory limit for the amount of ¹³⁷Cs which may be used during a logging operation is a maximum of 1.3 Curie. During density logging operations, a certain number of photons per second are required to enter into the detectors to ensure a high enough statistic for the purposes of data quality consistency and interpretation.

The operations cannot currently be performed using any radiation source other than harmful radioisotopes as the output of an x-ray tube isn't inherently stable enough over time to provide the statistics necessary for the accuracy required of the log, which is typically an uncertainty in measurement of 0.01 g/cc density.

By using a reference detector to correct the measured formation density. rather than using a reference detector to attempt to control the variations in the source, the use of x-ray tubes for formation evaluation becomes a real possibility.

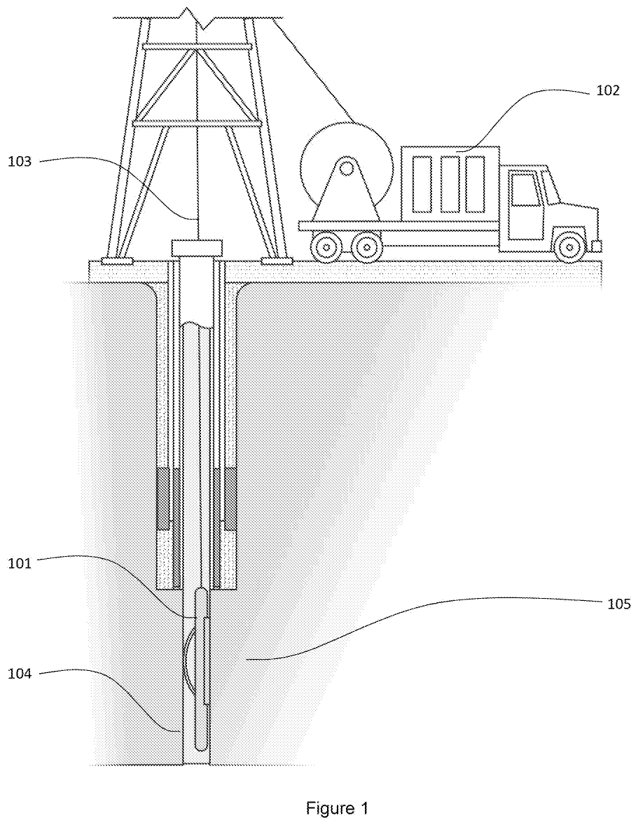

With reference now to the attached Figures, FIG. 1 illustrates an x-ray based litho-density formation evaluation tool [101] is deployed by wireline conveyance [102,103] into a borehole [104], wherein the formation [105] density is measured by the tool [101].

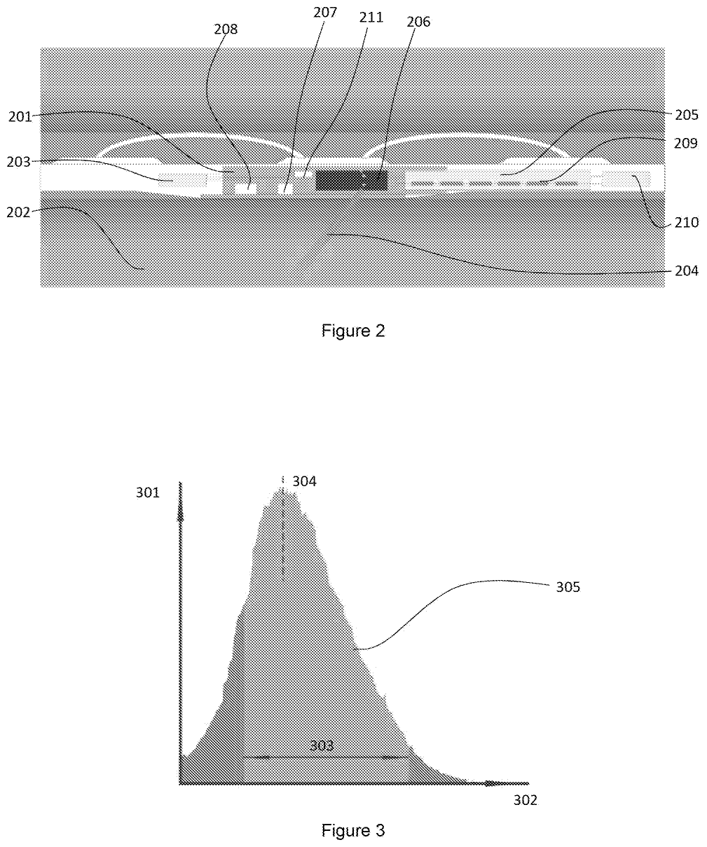

FIG. 2 is a layout of a practical means of exercising the method within the confines of a borehole tool configured to measure formation density and borehole corrections using an x-ray tube [206] as a radiation [204] source. The x-ray source [206] produces a beam of x-rays [204] that illuminates the formation [202]. The x-ray source output is monitored by a reference detector

No direct beam path through the shielding [201] that surrounds the source [206] and detectors [207, 208, 211] is necessary as the reference detector [211] uses the shielding [201] to attenuate the radiation emanating directly from the source [206]. The source tube [206] may be energized by a high-voltage generator [205] that, contains a sensing and feedback circuit [209] that provides control input to the high-voltage generator controller [210]. The reference detector [211] provides a spectrum to the density processing unit [203] such that adjustments to the outputs of the formation density detector [208] and borehole correction detector [207] may be made to account for any variations in the output of the x-ray source [206].

FIG. 3 illustrates a typical reference detector spectrum [305] for a Compton range source, showing Intensity in the y-axis [301] versus photon energy in the x-axis [302], the windowed region of interest [303] (the region between two specified energies) remains unchanged as the spectrum peak intensity [304] moves. The total number of counts within the region of interest form to basis for the calibration coefficient correction computation.

In one example embodiment, the x-ray based litho-density formation evaluation tool

is deployed by wireline conveyance [102,103] into a borehole [104], wherein the formation

density is measured by the tool [101]. The tool [101] is enclosed by a pressure housing [201] which ensures that well fluids are maintained outside of the housing. In a further embodiment, a tool [101] is configured to measure formation density and borehole corrections using an x-ray tube

as a radiation [204] source. The x-ray source [206] produces a beam of x-rays [204] that illuminates the formation [202]. The x-ray source output is monitored by a reference detector

. No direct beam path through the shielding [201] that surrounds the source [206] and detectors [207, 208, 211] is necessary as the reference detector [211] uses the shielding [201] to attenuate the radiation emanating directly from the source [206]. The source tube [206] may be energized by a high-voltage generator [205] that contains a sensing and feedback circuit [209] that provides control input to the high-voltage generator controller [210]. The reference detector [211] provides a spectrum to the density processing unit [203] such that adjustments to the outputs of the formation density detector [208] and borehole correction detector [207] may be made to account for any variations in the output of the x-ray source [206]. In a further embodiment, the reference detector [211] is made of a scintillator crystal, such as Sodium Iodide, Cesium Iodide or Lanthanum Bromide, with an embedded micro-isotope, to be used in detector gain stabilization, and is located in the radiation shielding [201] surrounding a source tube [206] . The output spectrum [305] is analyzed and a region of interest [303] applied to the spectrum [305]. The total number of counts within the region of interest [303] form the basis of an input to a calibration coefficient correction computation. In a further embodiment, the borehole logging tool [101] would function such that the source tube [206] illuminates a volume of formation [202], wherein the formation-facing detectors [207,208], which are also gain stabilized by an embedded micro-isotope technique, would record the resultant spectra by collecting the scattered photons emanating from the formation. The number of counts logged by the formation-facing detectors [207,208] would be modified, either as a computational step prior to, or during the computation of formation density based on the reference detector's [211] output. This would be achieved by comparing the reference detector's [211] output variance to a software table for the specific ambient temperature in which the tool [101] is operating. The table would be created during the initial factory-based characterization testing of the tool [101], wherein the tool [101] would be placed against volumes of materials of known density, such as magnesium and aluminum, which contain a detector placed within the volume of the known density block, within the illumination volume of the source tube. The tool would be operated during these characterization tests and the count rate from within the region of interest [303] of the reference detector [211] and the calibration block detector would be recorded as the temperature of the tool is increased in discrete steps up to the highest anticipated wellbore temperature. The variation between the absolute detector located in the calibration blocks and the reference detector [211] as a function of ambient temperature would then be tabulated and included in the firmware for that specific tool [101]. This table of calibration coefficients can then be used during density computation to correct the formation-facing detectors' [207,208], output for any variations in the source-tube's [206] output as a function of temperature based upon the known ‘absolute’ source output relative to the tabled, reference output. In a further embodiment, the density processing is performed within the tool [101]. In a further embodiment, the raw count data from the region of interest [303] of the gain-stabilized formation-facing detectors [207,208] would be sent to topside in addition to the computed calibration coefficient corrected count rate for each detector, along with the count rate data from the reference detector. The correction computation would be performed within the logging control unit located on topsides.

In a further embodiment, the resultant data can be utilized to form a log stability quality index parameter during the final production of the density log versus borehole depth.

In a still further embodiment, the tool [101] is located within a logging-while-drilling (LWD) string, rather than conveyed by wireline.

In a further embodiment still, the LWD provisioned tool [101] would be powered by mud turbines.

In yet another embodiment, the tool [101] is combinable with other measurement tools such as neutron-porosity, natural gamma and/or array induction tools.

Additionally, the invention allows for the inherent physical differences between all manufactured photo-multiplier tubes and the stabilization gain control voltages necessary to produce identical spectral outputs—as the output of the reference detector sub-system and radiation source and power supply are all functionally characterized as a whole system, rather than individual parts, the statistical output of the formation-facing detectors can be modified against a system-specific temperature dependent calibration table to ensure that all manufactured systems have identical statistical output.

Furthermore, the inherent stability of the traditional embedded micro-isotope technique for formation-facing detector gain stabilization is not affected by this measurement. As a result, the raw output count data would be logged/recorded un-altered. The tabled coefficient amendments to the data would only be applied to the data prior to or during the final density calculation—if any apparent discrepancy or out-of-bound data were to be produced by the reference detector, it can be filtered by the operator as the raw unaltered' detector data would be available.

Moreover, the invention does not require the complexities of a channel between the source tube and the reference detector to permit, the passage of radiation. The reference detector can be located within a void within the radiation shielding material surrounding the source tube such that the distance between the source tube and the reference detector is such that there is enough radiation to produce a reasonable statistical count rate but is attenuated enough to ensure that the reference detector does not saturate from too many incoming photons.

Also, the invention does not require the monitoring of energy peaks, other than what is inherent to the traditional embedded micro-isotope technique for formation-facing detector gain stabilization in the detector electronics. As a result, the necessity for beam-hardening or spectrum modifying filters is avoided.

Additionally, as a region of interest is employed while analyzing the output spectrum of reference detector, any undesirable effects associated with the modification of the form of the beam spectrum due to the radiation shielding can be circumvented as the region of interest can be tuned to select a spectral region above that of any major spectrum-clipping or hardening materials within the shielding.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. An x-ray based litho-density tool for measurement of formation surrounding a borehole. said tool comprising:
an internal length comprising a sonde section, wherein said sonde section further comprises an x-ray source; at least one radiation measuring detector; at least one source monitoring detector; a plurality of sonde-dependent electronics; and a reference detector,
wherein said reference detector is used to monitor the output of the x-ray source such that the reference detector's output effects corrections to the outputs of the detectors used to measure the density of the materials surrounding the borehole in order to correct for variations in the x-ray source output.

2. The tool of claim 1, further comprising a plurality of tool logic electronics and PSUs.

3. The tool of claim 1, further comprising a detector used to measure borehole standoff such that other detector responses may be compensated for tool standoff.

4. The tool of claim 1, further comprising a plurality of density measuring detectors.

5. The tool of claim 1, further comprising a tungsten shield.

6. The tool of claim 1, wherein the tool is configured so as to permit through wiring.

7. The tool of claim 1, wherein the tool further comprises a wear-pad disposed such that the source and detector assembly may be pressed against the side of the borehole to reduce borehole effects.

8. The tool of claim 1, wherein the reference detector is used to monitor the output of the x-ray source.
